(19) United States
(12) Patent Application Publication
(10) Pub. No.: US 2015/0056360 A1
(43) Pub. Date: Feb. 26, 2015

(54) CREAMER COMPOSITION COMPRISING PROTEIN, LOW MOLECULAR WEIGHT EMULSIFIERS AND HYDROXYPROPYL STARCH

(71) Applicant: NESTEC S.A., Vevey (CH)

(72) Inventors: Christine Ann Beeson, Marysville, OH (US); Alexander A. Sher, Dublin, OH (US)

(21) Appl. No.: 14/390,868

(22) PCT Filed: Mar. 25, 2013
(86) PCT No.: PCT/EP13/56243

§ 371 Date: Oct. 6, 2014

Related U.S. Application Data
(60) Provisional application No. 61/620,240, filed on Apr. 4, 2012.

(51) Int. Cl. A23L 1/19; A23L 2/52

(52) U.S. Cl. CPC A23L 1/19; A23L 2/52
USPC 426/593; 426/654; 426/590; 426/594; 426/597

(57) ABSTRACT

The present invention relates to a creamer composition, e.g. for use for addition into a coffee beverage, having good physical stability and mouthfeel even at low fat levels or as a fat free creamer composition. The creamer comprises protein, low molecular weight emulsifier and hydroxypropyl starch. The invention further relates to a method of producing the creamer, a beverage composition comprising the creamer, and a method of producing a beverage composition.

### FIELD OF THE INVENTION

The present invention relates to creamers that may be used e.g. for adding to coffee, tea, and cocoa beverages, and to methods of producing creamers.

### BACKGROUND

Creamers are widely used as whitening agents with hot and cold beverages such as, for example, coffee, cocoa, tea, etc. They are commonly used in place of milk and/or dairy cream. Creamers may come in a variety of different flavors and provide mouthfeel, body, and a smoother texture. Creamers can be in liquid or powder forms. A liquid creamer may be intended for storage at ambient temperatures or under refrigeration, and should be stable during storage without phase separation, creaming, gelation and sedimentation. The creamer should also retain a constant viscosity over time. When added to cold or hot beverages such a coffee or tea, the creamer should dissolve rapidly, provide a good whitening capacity, and remain stable with no feathering and/or sedimentation while providing a superior taste and mouthfeel. Mouthfeel, also denoted richness, texture or creaminess, is usually provided by the oil emulsion present in the creamer. However, consumers are looking for lower calorie beverages with less, or no, fat and in such products it is difficult to obtain the mouthfeel consumers expect of creamers. Even solutions that improve the viscosity of a liquid creamer itself often do not provide the desired mouthfeel in a beverage to which it is added in a small amount. It is a challenge to obtain the desired mouthfeel in the final beverage without excessive viscosity or loss of stability in the creamer itself. Modified starches are normally used in products where a high viscosity and a high degree of texture is desired, e.g. in instant desserts, pizza toppings, frozen foods, ice-cream, frozen cakes, dry mixes (cupcakes, muffins, cakes, cookies, self-saucing puddings), flavoured toppings and sauces, mayonnaises, snacks and muesli bars, and gravies.

In view of the previous discussion, there are numerous challenges in creating a liquid creamer with no, or reduced, fat content, which is liquid and pourable and provides the desired mouthfeel when added to a beverage, as well as being homogeneous, shelf-stable, and with good physical stability.

### SUMMARY OF THE INVENTION

The inventors have surprisingly found that hydroxypropyl starch can be used to improve the mouthfeel when a liquid creamer is added to a beverage, and provide a good physical stability without excessive viscosity. Accordingly, the present invention relates to a creamer composition comprising protein, hydroxypropyl starch and low molecular weight emulsifier. In further embodiments, the invention relates to a method of producing a creamer composition of the invention as well as a method of preparing a beverage composition.

### DETAILED DESCRIPTION OF THE INVENTION

According to the present invention a creamer composition is provided which has a good physical stability and provides a pleasant mouthfeel when added to a beverage. By physical stability is meant stability against phase separation, plug formation, flocculation and/or aggregation of fat due to fat crystallization and/or formation of an oil rich fraction in the upper part of the composition due to aggregation and/or coalescence of oil droplets, e.g. aggregation and/or coalescence of oil droplets to form cream layer” in the upper part of the product.

By a creamer composition is meant a composition that is intended to be added to a food composition, such as e.g. coffee or tea, to impart specific characteristics such as colour (e.g. whitening effect), flavour, texture, mouthfeel and/or other desired characteristics. A creamer composition of the invention is preferably in liquid form, but may also be in powdered form.

The creamer composition of the invention comprises hydroxypropyl starch. Hydroxypropyl starch is a derivative of natural starch. Linear and branched carbohydrate polymers in natural starch have three reactive OH groups on each glucose unit. During manufacture of hydroxypropyl starch, these polymers are reacted with propylene oxide, adding hydroxypropyl (CH(OH)CH₂CH₃) groups at the OH positions by an ether linkage. Modification is usually carried out by propylene oxide at levels up to 25% and the resultant starch is often lightly oxidized, bleached or acid modified after etherification. Substitution normally amounts to a maximum of 40 ether linkages per 100 glucopyranose units if 25% propylene oxide is used, and 4-6 ether linkages per 100 glucopyranose units if 5% propylene oxide is used.

Hydroxypropyl starch is preferably present in the creamer composition of the invention in an amount of between about 0.2% and about 2% (weight/weight), such as between about 0.3% and about 1.5%, more preferably between about 0.4% and about 1%. At too high levels of hydroxypropyl starch phase separation may occur.

The creamer composition of the invention further comprises protein, preferably between about 0.1% (weight/weight) and about 3% protein, such as between about 0.2% (weight/weight) and about 2% protein, more preferably between about 0.5% (weight/weight) and about 1.5% protein. The protein may be any suitable protein, e.g. milk protein, such as casein, caseinate, and whey protein; vegetable protein, e.g. soy and/or pea protein; and/or combinations thereof. The protein is preferably sodium caseinate. The protein in the composition may work as an emulsifier, provide texture, and/or provide whitening effect. Too low levels of protein may reduce the stability of the liquid creamer. At too high protein levels the viscosity of the product may be higher than desired and too high for liquid processing.

The creamer composition of the invention comprises low molecular weight emulsifiers. By a low molecular weight emulsifier is meant an emulsifier with a molecular weight below 1500 g/mol. Emulsions are thermodynamically unstable, and the phases of an emulsion will separate with time. By an emulsifier is meant a compound that stabilises the interface between the two phases of the oil-in-water emulsion and reduces the rate of phase separation.

Low molecular weight emulsifiers include, but are not limited to, monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, lecithins, lysolecithins, succinic acid esters of mono- and/or diglycerides, lactic acid esters of mono- and/or diglycerides, lecithins, lysolecitins, and sucrose esters of fatty acids. Low molecular emulsifiers may e.g. be present in an amount of between about 0.05% and 1.0% (weight/weight), preferably between about 0.1% and 0.8%. Too high or too low levels of low molecular emulsifier may lead to instability, e.g. in the form of creaming.

In one embodiment, a creamer composition according to the invention comprises low molecular weight emulsifier selected among monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, lecithins, lysolecithins, succinic acid esters of mono- and/or diglycerides, lactic acid esters of mono- and/or diglycerides, lecithins, lysolecitins, and sucrose esters of fatty acids, lecithin (e.g. soy lecithin, canola lecithin, sunflower lecithin, and/or safflower lecithin), lysolecithins, and combinations thereof.

The hydrophilicity and lipophilicity are different among emulsifiers, and the balance between the two is called the hydrophilic-lipophilic balance HLB value. The HLB value is determined by calculating hydrophilic or lipophilic values of the different regions of the molecule. Various references discuss the HLB value. Examples are Griffin W C: “Classification of Surface-Active Agents by ‘HLB,’” Journal of the Society of Cosmetic Chemists 1 (1949): 311, or Griffin W C: “Calculation of HLB Values of Non-Ionic Surfactants,” Journal of the Society of Cosmetic Chemists 5 (1954): 259, which are incorporated herein by reference. The HLB value of an emulsifier typically ranges from 0 to 20. Low HLB values range from about 1 to about 5. Medium HLB values range from about 5 to about 10. Low molecular weight emulsifiers with low HLB values can include, but are not limited to, monoglycerides, diglycerides, acetylated monoglycerides, sorbitan trioleate, glycerol dioleate, sorbitan tristearate, propyleneglycol monostearate, glycerol monooleate and monostearate, alone or in combination. The low molecular weight emulsifiers with medium HLB values can include, but are not limited to, sorbitan monooleate, propylene glycol monolaurate, sorbitan monostearate, calcium stearoxyl-2-lactylate, glycerol sorbitan monopalmitate, soy lecithin, canola lecithin, sunflower lecithin, safflower lecithin, and diacetylated tartaric acid esters of monoglycerides, alone or in combination. In one embodiment, the creamer composition comprises both low molecular weight emulsifier with low HLB value and low molecular weight emulsifier with medium HLB value, e.g. in a weight ratio of between about 1:1 and about 1:10, preferably between 1:2 and 1:5, between low and medium HLB value low molecular weight emulsifier. In a preferred embodiment the low molecular emulsifier comprises monoglycerides and diacetylated tartaric acid esters of monoglycerides, e.g. in a weight ratio of between about 1:1 and about 1:10, preferably between 1:2 and 1:5, between monoglycerides and diacetylated tartaric acid esters of monoglycerides.

In one embodiment of the invention, the weight ratio of low molecular emulsifier to protein is between about 1:0.1 and about 1:60. In another embodiment of the invention, the weight ratio of low molecular emulsifier to protein to hydroxypropyl starch is 1 to (0.1-60) to (0.2-40).

In one embodiment, the creamer composition of the invention comprises oil. The oil may be any oil, or combination oils, suitable for use in a liquid creamer. The oil is preferably a vegetable oil, such as e.g. oil from canola, soy bean, sunflower, safflower, cotton seed, palm oil, palm kernel oil, corn, and/or coconut. The oil is preferably present in an amount of at most about 15% (weight/weight), the amount of oil in the creamer composition may e.g. be between about 1% and about 15% (weight/weight), such as between about 2% and about 10%. In another embodiment the creamer composition of the invention is oil free.

The creamer composition of the invention may comprise a hydrocolloid. Hydrocolloids may help to improve physical stability of the composition. Suitable hydrocolloids may e.g. be carrageenan, such as kappa-carragenan, iota-carragenan, and/or lambda-carragenan; starch, e.g. modified starch; cellulose, e.g. microcrystalline cellulose, methyl cellulose, or carboxy-methyl cellulose; agar-agar; gelatine; gellan (e.g., high acyl, low acyl); guar gum; gum Arabic; kojac; locust bean gum; pectin; sodium alginate; maltodextrin; tracaganth; xanthan; or a combination thereof.

The creamer composition of the present invention may further include a buffering agent. The buffering agent can prevent undesired creaming or precipitation of the creamer upon addition into a hot, acidic environment such as coffee. The buffering agent can e.g. be monophosphates, diphosphates, sodium mono- and bicarbonates, potassium mono- and bicarbonates, or a combination thereof. Preferred buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer may e.g. be present in an amount of about 0.1 to about 1% by weight of the liquid creamer.

The creamer composition of the present invention may further include one or more additional ingredients such as flavors, sweeteners, colorants, antioxidants (e.g. lipid antioxidants), or a combination thereof. Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination.

Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used. In one embodiment, a sweetener is present in the creamer composition of the invention at a concentration ranging from about 5% to about 35% by weight. In another embodiment, the sweetener concentration ranges from about 10% to about 25% by weight.

The invention further relates to a method of producing a creamer composition of the invention. The method comprises providing a composition, the composition comprising water, protein, hydroxypropyl starch and low molecular weight emulsifier, and optionally additional ingredients as disclosed herein; and homogenising the composition to produce a creamer composition. Before homogenisation, optional compounds such as, hydrocolloids, buffers, sweeteners and/or flavors may be hydrated in water (e.g., at between 40° C. and 90° C.) under agitation, with addition of melted oil if desired. The method may further comprise heat treating the composition before homogenisation, e.g. by aseptic heat treatment. Aseptic heat treatment may e.g. use direct or indirect UHT processes. UHT processes are known in the art. Examples of UHT processes include UHT sterilization and UHT pasteurization. Direct heat treatment can be performed by injecting steam into the emulsion. In this case, it may be necessary to remove excess water, for example, by flashing. Indirect heat treatment can be performed with a heat transfer interface in contact with the emulsion. The homogenization may be performed before and/or after heat treatment. It may be advantageous to perform homogenization before heat treatment if oil is present in the composition, in order to improve heat transfers in the emulsion, and thus achieve an improved heat treatment. Performing a homogenization after heat treatment usually ensures that the oil droplets in the emulsion have the desired dimension. After heat treatment the product may be filled into any suitable packaging, e.g. by aseptic filling. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. Pat. No. 6,536,188 to Taggart, which are incorporated herein by reference. In an embodiment, the method comprises heat treating the liquid creamer before filling the container. The method can also comprise adding a buffering agent in amount ranging from about 0.1% to about 1.0% by weight to the liquid creamer before homogenizing the liquid creamer. The buffering agent can be one or more of sodium mono- and di-phosphates, potassium mono-and di-phosphates, sodium mono- and bi-carbonates, potassium mono- and bi-carbonates or a combination thereof.

The creamer, when added to a beverage, produces a physically stable, homogeneous, whitened drink with a good mouthfeel, and body, smooth texture, and a pleasant taste with no off-flavors notes. The use of the creamer of the invention is not limited for only coffee applications. For example, the creamer can be also used for other beverages, such as tea or cocoa, or used with cereals or berries, as a creamer for soups, and in many cooking applications, etc. A liquid creamer of the invention is preferably physically stable and overcome phase separation issues (e.g., creaming, plug formation, gelation, syneresis, sedimentation, etc.) during storage at refrigeration temperatures (e.g., ˜4° C.), room temperatures (e.g., ˜20° C.) and elevated temperatures (e.g., ˜30 to 38° C.). The stable liquid creamers can have a shelf-life stability such as at least 6 months at 4° C. and/or at 20° C., 6 months at 30° C., and 1 month at 38 ° C. Stability may be evaluated by visual inspection of the product after storage.

The invention in an even further aspect relates to a beverage composition comprising a creamer composition as disclosed above. A beverage composition may e.g. be a coffee, tea, malt, cereal or cocoa beverage. A beverage composition may be liquid or in powder form. Accordingly, the invention relates to a beverage composition comprising a) a creamer composition of the invention, and b) a coffee, tea, malt, cereal, or cocoa product, e.g. an extract of coffee, tea, malt, or cocoa. If the beverage composition is in liquid form it may e.g. be packaged in cans, glass bottles, plastic bottles, or any other suitable packaging. The beverage composition may be aseptically packaged. The beverage composition may be produced by a method comprising a) providing a beverage composition base; and b) adding a creamer composition according to the invention to the beverage composition base. By a beverage composition base is understood a composition useful for producing a beverage by addition of a creamer of the invention. A beverage composition base may in itself be suitable for consumption as a beverage. A beverage composition base may e.g. be an extract of coffee, tea, malt, or cocoa.

### EXAMPLES

By way of example and not limitation, the following examples are illustrative of various embodiments of the present disclosure.

### Example 1

A dry blend consisting of 100 g Dimodan (monoglycerides) and 300 g of Panodan (diacetylated tartaric acid esters of monoglycerides), 0.5 kg of hydroxypropyl starch, 50 g of flavor, 1000 g of sodium caseinate, 400 g of di-potassium phosphate and 30 kg of sucrose was added to 55 kg of hot water (˜65° C.) under high continuous agitation.

After ˜10 minutes of mixing, 12 kg of canola oil was added under high agitation. Small amount of additional water was added to adjust the total product amount to 100 kg.

The composition was pre-heated, UHT treated for 5 sec at 143° C., homogenized at 180/40 bar and cooled. The resulting liquid creamer was aseptically filled into bottles. The liquid creamer was stored 7 months at 4° C., and also at room temperature and elevated temperatures.

The sensory characteristics of creamer and coffee beverages with added liquid creamer were judged by sensory panelists. It was found by the panel that the liquid creamer when added to hot coffee was consistently judged to have higher mouthfeel than a control sample without hydroxypropyl starch. Further, the observation showed good physical stability of the liquid creamers as is and when added to hot coffee.

It was surprisingly found that the liquid creamer has not only improved mouthfeel but also has good appearance, smooth texture and a good flavor without “off”-taste. In addition, the creamer showed high whitening capacity when added to a coffee.

### Example 2

A dry blend consisting of 100 g Dimodan and 300 g of Panodan, 0.5 kg of hydroxypropyl starch, 50 g of flavor, 1000 g of sodium caseinate, 400 g of di-potassium phosphate and 11 kg of corn syrup solids was added to 70 kg of hot water (˜65° C.) under high continuous agitation.

After ˜10 minutes of mixing, 7 kg of canola oil was added under high agitation. Small amount of additional water was added to adjust the total product amount to 100 kg.

The composition was pre-heated, UHT treated for 5 sec at 143° C., homogenized at 180/40 bar and cooled. The resulting liquid creamer was aseptically filled into bottles. The liquid creamers were stored 7 months at 4° C., and also at room temperature and elevated temperatures.

The sensory characteristics of creamer and coffee beverages with added liquid creamer were judged by non-trained sensory panelists. It was found by the panel that the liquid creamer when added to hot coffee was consistently judged to have higher mouthfeel than a control sample without hydroxypropyl starch. Further, the observation showed good physical stability of the liquid creamers as is and when added to hot coffee.

It was surprisingly found that the liquid creamer has not only improved mouthfeel but also has good appearance, smooth texture and a good flavor without “off”-taste. In addition, the creamer showed high whitening capacity when added to a coffee.

### Example 3

A dry blend consisting of 100 g Dimodan and 300 g of Panodan, 0.5 kg of hydroxypropyl starch, 50 g of flavor, 1000 g of sodium caseinate, 400 g of di-potassium phosphate and 30 kg of sucrose was added into 55 kg of hot water (˜65° C.) under high continuous agitation.

After ˜10 minutes of mixing, 2 kg of canola oil was added under high agitation. Small amount of additional water was added to adjust the total product amount to 100 kg.

The composition was pre-heated, UHT treated for 5 sec at 143° C., homogenized at 180/40 bar and cooled. The resulting liquid creamer was aseptically filled into bottles. The liquid creamers were stored 7 months at 4° C., and also at room temperature and elevated temperatures.

The sensory characteristics of creamer and coffee beverages with added liquid creamer were judged by sensory panelists. It was found by the panel that the liquid creamer when added to hot coffee was consistently judged to have higher mouthfeel than a control sample without hydroxypropyl starch. Further, the observation showed good physical stability of the liquid creamers as is and when added to hot coffee.

It was surprisingly found that the liquid creamer has not only improved mouthfeel but also has good appearance, smooth texture and a good flavor without “off”-taste. In addition, the creamer showed high whitening capacity when added to a coffee.

### Example 4

A dry blend consisting of 100 g Dimodan and 300 g of Panodan, 0.5 kg of hydroxypropyl starch, 50 g of flavor, 1000 g of sodium caseinate, 400 g of di-potassium phosphate and 30 kg of sucrose was added into 55 kg of hot water (˜65° C.) under high continuous agitation.

After ˜10 minutes of mixing, small amount of additional water was added to adjust the total product amount to 100 kg.

The composition was pre-heated, UHT treated for 5 sec at 143° C., homogenized at 180/40 bar and cooled. The resulting liquid creamer was aseptically filled into bottles. The liquid creamers were stored 7 months at 4° C., and also at room temperature and elevated temperatures.

The sensory characteristics of creamer and coffee beverages with added liquid creamer were judged by sensory panelists. It was found by the panel that the liquid creamer when added to hot coffee was consistently judged to have higher mouthfeel than a control sample without hydroxypropyl starch. Further, the observation showed good physical stability of the liquid creamers as is and when added to hot coffee.

It was surprisingly found that the liquid creamer has not only improved mouthfeel but also has good appearance, smooth texture and a good flavor without “off”-taste. In addition, the creamer showed high whitening capacity when added to a coffee.

### Example 5

A liquid creamer was prepared as in Example 2 but using 2.2 kg of hydroxypropyl starch. The creamer was unacceptable due to extreme phase separation (serum).

### Example 6

A liquid creamer was prepared as in Example 2 but using 0.1 kg of hydroxypropyl starch.

The sensory characteristics of creamer and coffee beverages with added liquid creamer were judged by sensory panelists. No improvement in mouthfeel of hot coffee with the creamer added was found compared to a control sample without hydroxypropyl starch.

### Example 7

A liquid creamer was prepared as in Example 1 but using 17% fat and 2.0 kg of hydroxypropyl starch.

The viscosity was unacceptably high for processing and the product became unstable.

### Example 8

A liquid creamer was prepared as in Example 1 but using 0.05 kg of sodium caseinate and 2.0 kg of hydroxypropyl starch. The product was not stable.

### Example 9

A liquid creamer was prepared as in Example 1 but using 3.5 kg of sodium caseinate and 2.0 kg of hydroxypropyl starch. Viscosity was unacceptably high for processing.

### Example 10

A liquid creamer was prepared as in Example 1 but using 45 kg of sugar and 2.0 kg of hydroxypropyl starch. Viscosity was unacceptably high for processing and in the final product.

### Example 11

A liquid creamer was prepared as in Example 1 but using 10 g Dimodan and 30 g of Panodan. Samples were unacceptable due to stability issues such as creaming.

### Example 12

A liquid creamer was prepared as in Example 1 but using 300 g Dimodan and 900 g of Panodan. Samples were unacceptable due to stability issues such as serum and creaming.

### Example 13

Liquid creamer compositions were prepared as in Example 1, except that instead of the amount of hydroxypropyl starch given in Example 1, the ingredients listed in Table 1 were used in. Each row of Table 1 corresponds to one creamer composition. Observations from sensory characterisation and stability evaluation are given in table 1.

TABLE 1

| | | Sensory | Stability | |
|---|---|---|---|---|
| Ingredient | % w/w | Result | Result | Comments |
| Lamba | 0.150 | no effect | stable | |
| Carrageenan | | | | |
| Gum Arabic, FT | 1.0 | no effect | stable | |
| pwd, Gum Acacia | | | | |
| waxy maize starch | 2.5 | no effect | stable | no improvement in |
| | | | | mouthfeel in coffee |
| | | | | or as is |
| starch, sodium | 2.5 | no effect | stable | no improvement in |
| octenyl succinate | | | | mouthfeel in coffee |
| | | | | or as is |
| Acid modified | 2.5 | no effect | stable | no improvement in |
| waxy maize | | | | mouthfeel in coffee |
| | | | | or as is |
| arabinogalactan | 2.5 | no effect | stable | no improvement in |
| from larch tree | | | | mouthfeel in coffee |
| | | | | or as is |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A creamer composition comprising protein, hydroxypropyl starch and low molecular weight emulsifier.

2. The creamer composition of claim 1 comprising between about 0.2% and about 2% hydroxypropyl starch.

3. The creamer composition of claim 1 comprising between about 0.1% and about 3% protein.

4. The creamer composition of claim 1 comprising between about 0.05% and about 1.0% low molecular weight emulsifier.

5. The creamer composition of further claim 1 comprising oil.

6. The creamer composition of claim 5 comprising between about 1% and about 15% oil.

7. The creamer composition of further claim 1 comprising sugar.

8. The creamer composition of claim 1 comprising between about 5% and about 35% sugar.

9. The creamer composition of claim 1, wherein the low molecular weight emulsifier is selected from the group consisting of monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, lecithins, lysolecithins, succinic acid esters of mono- and/or diglycerides, lactic acid esters of mono- and/or diglycerides, lecithins, lysolecitins, and sucrose esters of fatty acids, lecithin, lysolecithins, and combinations thereof.

10. A beverage composition comprising a creamer composition comprising protein, hydroxypropyl starch and low molecular weight emulsifier.

11. The beverage composition of claim 10, wherein the beverage is selected from the group consisting of a coffee, tea, malt, cereal, and cocoa beverage composition.

12. A method of producing a creamer composition, comprising:
providing a composition comprising water, protein, hydroxypropyl starch and low molecular weight emulsifier; and
homogenising the composition to produce a creamer composition.

13. A method of preparing a beverage composition, the method comprising:
providing a beverage composition base; and
adding a creamer composition comprising protein, hydroxypropyl starch and low molecular weight emulsifier to the beverage composition base.

14. The method of claim 13 wherein the beverage composition is selected from the group consisting of a coffee, tea, malt, cereal, and cocoa beverage.

15. A beverage composition obtainable by the method of claim 13.
